(19) United States
(12) Patent Application Publication
(10) Pub. No.: US 2007/0192112 A1
(43) Pub. Date: Aug. 16, 2007

(54) A Method for Providing Pavement Degradation Equipment

(76) Inventor: David R. Hall, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/307,527

(22) Filed: Feb. 10, 2006

(51) Int. Cl. G06Q 99/00

(52) U.S. Cl. 705/1

(57) ABSTRACT

A method for providing pavement degradation equipment comprises the following steps: a first party providing pavement degradation equipment to a second party, the pavement degradation equipment comprising at least one tool comprising a first end adapted for connection to a motor vehicle and a second end comprising a superhard material for engagement with the pavement; using a rental agreement comprising terms of payment based on use of the equipment; the first party providing a mechanism for measuring the use of the equipment; and the first party charging the second party for use of the equipment according to the terms of the rental agreement.

### BACKGROUND OF THE INVENTION

In the transportation industry, more emphasis has been put on recycling asphalt which may be used in new and old roads. Asphalt has become the most recycled material in the United States with typically more than 70 million metric tons being recycled every year. Using recycled materials for new and old roads is important to citizens, cities, and states throughout the country because it is more convenient and saves time and money.

Tools such as picks, rippers, scarifiers, and hammers may be used to degrade pavement. These tools may comprise a material such as hardened steel or tungsten carbide which may wear when it contacts the pavement. Companies providing pavement degradation tools may check the tools periodically and replace them when needed. The result may be lost time and money while machines and crews wait for the picks to be inspected and replaced.

### BRIEF SUMMARY OF THE INVENTION

In one aspect of the invention, a method comprises the following steps: a first party providing pavement degradation equipment to a second party, using a rental agreement comprising terms of payment based on use of the equipment, the first party providing a mechanism for measuring the use of the equipment, and the first party charging the second party for use of the equipment according to the terms of the rental agreement. The equipment comprises at least one tool comprising a first end adapted for connection to a motor vehicle and a second end comprising a superhard material for engagement with the pavement. The superhard material may be diamond, polycrystalline diamond, boron nitride, or combinations thereof.

### BRIEF DESCRIPTION OF THE DRAWINGS

The foregoing and other features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings.

FIG. 1 is a schematic of an embodiment of a method for providing pavement degradation equipment.

FIG. 2 is a schematic of another embodiment of a method for providing pavement degradation equipment.

FIG. 3 is an orthogonal diagram of an embodiment of an at least one tool and a holder.

FIG. 4 is a perspective diagram of an embodiment of a part of a motor vehicle adapted to receive a first end of a pavement degradation tool.

FIG. 5 is an orthogonal diagram of an embodiment of tools on a rotating drum attached to a motor vehicle.

FIG. 6 is a perspective diagram of another embodiment of at least one tool.

FIG. 7 is a cross-sectional perspective diagram of an array of tools.

FIG. 8 is an orthogonal diagram of an embodiment of a ripper attached to a motor vehicle.

FIG. 9 is a perspective diagram of an embodiment of mechanized hammers attached to a motor vehicle.

FIG. 10 is a bottom diagram an embodiment of a grinder pad.

FIG. 11 is a perspective diagram of an embodiment of a second end of a tool.

FIG. 12 is a perspective diagram of an embodiment of surveyors measuring a volume of degraded pavement.

FIG. 13 is an orthogonal diagram of an embodiment of a laser system attached to a motor vehicle.

### DETAILED DESCRIPTION OF THE INVENTION AND THE PREFERRED EMBODIMENT

It will be readily understood that the components of the present invention, as generally described and illustrated in the Figures herein, may be arranged and designed in a wide variety of different configurations. Thus, the following more detailed description of embodiments of the methods of the present invention, as represented in the Figures is not intended to limit the scope of the invention, as claimed, but is merely representative of various selected embodiments of the invention.

The illustrated embodiments of the invention will best be understood by reference to the drawings, wherein like parts are designated by like numerals throughout. Those of ordinary skill in the art will, of course, appreciate that various modifications to the methods described herein may easily be made without departing from the essential characteristics of the invention, as described in connection with the Figures. Thus, the following description of the Figures is intended only by way of example, and simply illustrates certain selected embodiments consistent with the invention as claimed herein.

In this application, “pavement” or “paved surface” refers to any artificial, wear-resistant surface that facilitates vehicular, pedestrian, or other form of traffic. Pavement may include composites containing oil, tar, tarmac, macadam, tarmacadam, asphalt, asphaltum, pitch, bitumen, minerals, rocks, pebbles, gravel, sand, polyester fibers, Portland cement, petrochemical binders, or additives. The term “degrade” or “degradation” is used in this application to mean milling, grinding, cutting, ripping apart, tearing apart, or otherwise taking or pulling apart a pavement material into smaller constituent pieces. The term “mechanism” is defined as a process or technique for achieving a result.

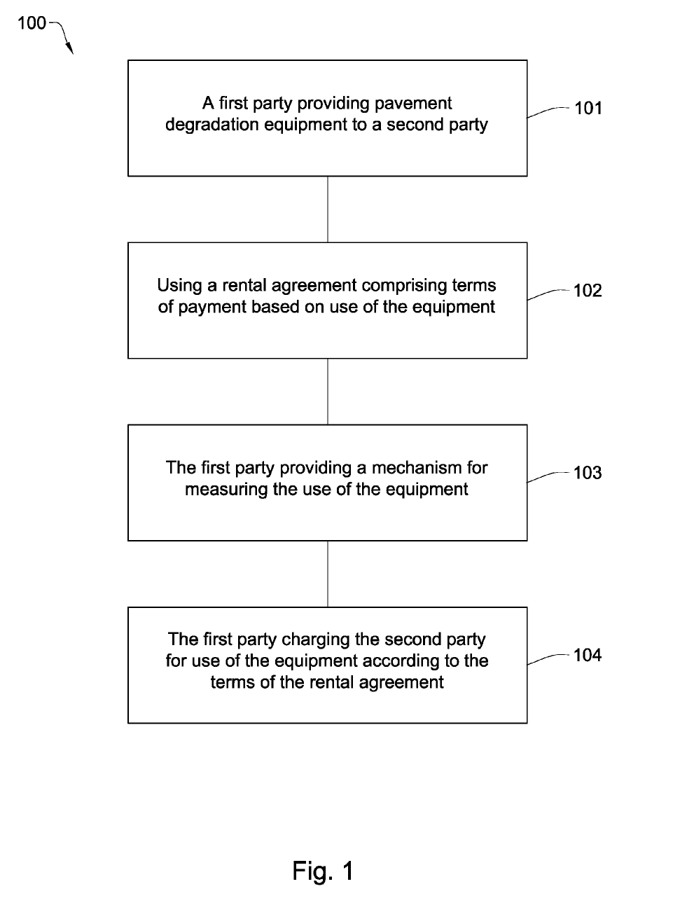

FIG. 1 is a schematic of an embodiment of a method 100 for providing pavement degradation equipment. The first step of the method 100 is a first party providing 101 pavement degradation equipment to a second party. The second party may be end users or agents of end users. The end user may comprise an agent for the entity renting the equipment, contractual employee, part-time employee, full-time employee, seasonal employee, volunteer, or combinations thereof. The pavement degradation equipment comprises at least one tool comprising a first end adapted for connection to a motor vehicle and a second end comprising a superhard material for engagement with the pavement. The pavement degradation equipment may also comprise at least one part of the motor vehicle which may be a cylindrical mass, a tool holder, a ripper attachment, a scarifier attachment, a grinder motor, a grinder axle, an array of hammers, or other piece of pavement degradation equipment that may be attached to a motor vehicle. The at least one tool may be a pick used to degrade pavement. Another step of the method 100 is using 102 a rental agreement comprising terms of payment based on use of the equipment. Another step is the first party providing 103 a mechanism for measuring the use of the equipment, and an additional step is the first party charging 104 the second party for use of the equipment according to the terms of the rental agreement. The method 100 may comprise an additional step of the first party receiving payment for the use of the equipment.

The first party may be at least one person who is an employee and/or an agent of the entity providing the pavement degradation equipment. The step of providing 101 pavement degradation equipment may comprise renting or leasing. Renting or leasing tools with a superhard material may be advantageous because the second party's cost is reduced. It is believed that the tool comprising a superhard material on the second end may have a longer life span than a traditional tool. Renting such a tool may generate better economic results for both the first and second party. For example, if the traditional tool had a life span of three hours and was available for purchase at three dollars, and a rented tool had a life span of sixty hours, the rented tool could be rented for one dollar per hour, the same cost as the traditional tool, and realize a higher overall revenue while saving the second party the expense of maintenance and repeated purchases.

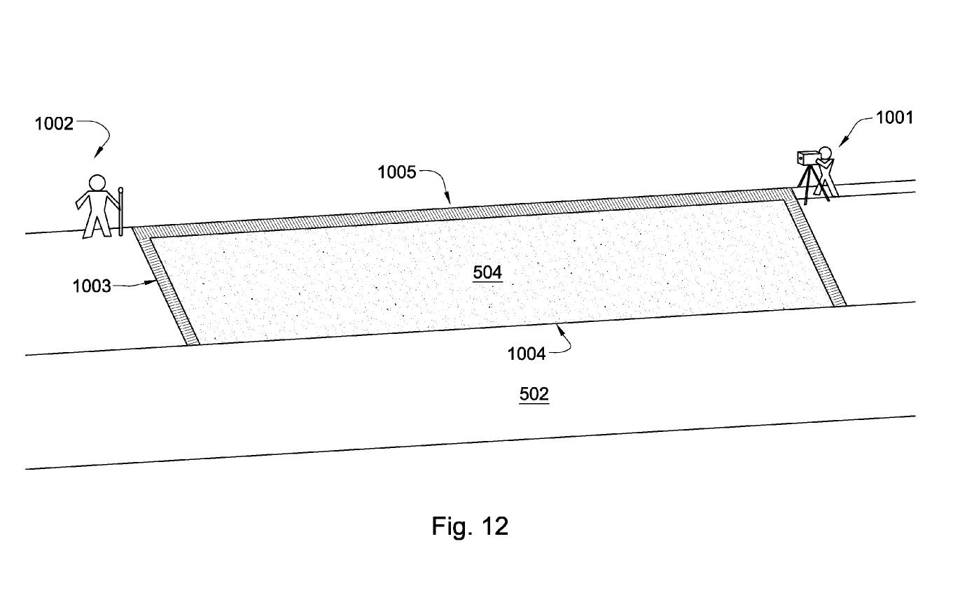

The rental agreement may state terms such as how the use of the equipment is measured and what the second party may do with the rented equipment. The use of the equipment may be determined by measuring. The terms regarding measuring may be addressed in the rental agreement and may be selected from the group consisting of measuring a volume of degraded pavement, measuring linear feet of degraded pavement, measuring an area of degraded pavement, measuring an amount of pavement degradation equipment, measuring the time that the pavement degradation equipment is in use by the second party, measuring the time that the pavement degradation equipment is in the second party's possession, measuring wear of the equipment while in the possession of the second party, measuring the number of times the second end of the at least one tool engages the pavement, measuring the weight of degraded pavement, or combinations thereof. Also the use of the equipment may be determined by type of pavement degradation equipment, by the material being degraded, or combinations thereof. Details concerning how these are to be measured will be addressed more fully in FIG. 12. The amount the second party may be charged may be determined according to terms that may be in the rental agreement. There may be pre-determined rates for different materials being degraded or there may be minimum requirements, i.e. a minimum of 100 tools must be ordered.

The rental agreement may also describe what the second party may do with the pavement degradation equipment. What may be done comprises actions selected from the group consisting of changing the tool after a pre-determined time and returning used and/or unused equipment. Such provisions enable the tools to be returned and recycled to reduce the cost of the tools. To ensure the return of rented equipment, the rental agreement may include a provision providing an incentive for the second party to return the equipment with undamaged superhard material. The incentive may comprise a credit toward future tool rentals, a partial refund, return of a deposit required prior to rental, or combinations thereof. The method may also include the first party allowing the superhard material to be recycled by the first party, the second party, or a third party. This allows the first party to control where the superhard material goes and who benefits from the return and recycle of the superhard material. It may be beneficial to have the tools returned, because the superhard material may be undamaged or have very little wear. If the superhard material is reusable, it may be removed using a tool and/or machine able to remove the superhard material from the tool. The superhard material may then be bonded to another tool. The cost of the tool may be reduced by recycling it in this manner.

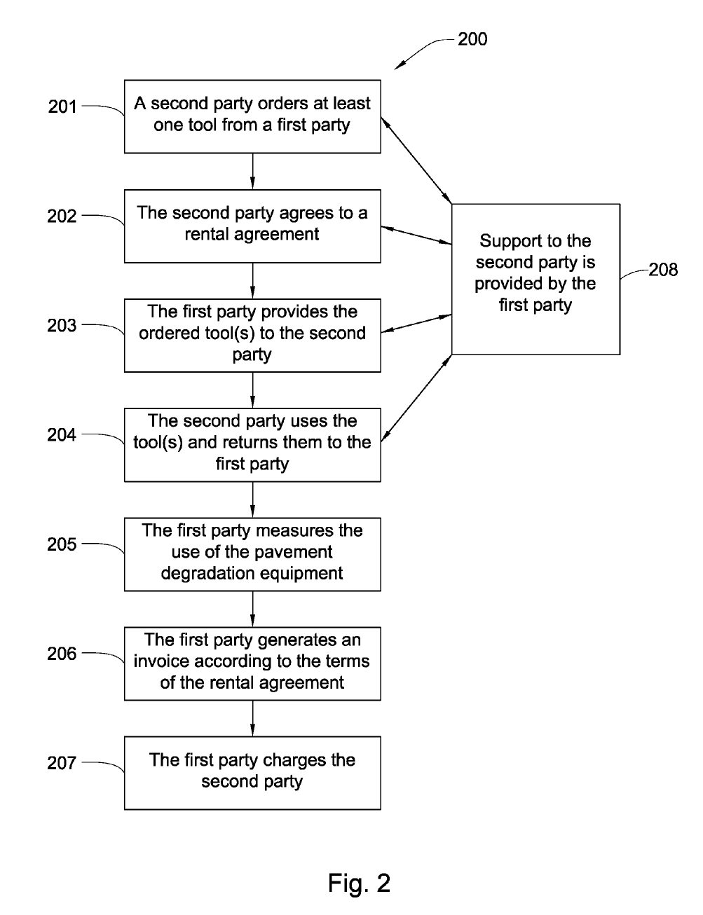

FIG. 2 is a schematic of another embodiment of a method 200 for providing pavement degradation equipment. A second party orders 201 equipment from a first party. The equipment includes at least one tool comprising a first end adapted for connection to a motor vehicle and a second end comprising a superhard material for engagement with the pavement. The second party agrees to 202 a rental agreement and the first party then provides 203 the ordered tools to the second party. After the second party uses the equipment, the second party returns 204 the equipment to the first party. The first party measures 205 the use of the pavement degradation equipment, generates 206 an invoice according to the terms of the rental agreement, and then the first party charges 207 the second party.

Still referring to FIG. 2, the method 200 may further comprise the step of providing 208 support to the second party by the first party. Providing 208 support may comprise helping the second party determine what equipment best fits a need, repairing the rented pavement degradation equipment, maintaining the rented pavement degradation equipment, replacing rented degradation equipment that is used or broken, inspecting rented pavement degradation equipment, training operators of pavement degradation motor vehicles in the use of the rented equipment, or combinations thereof. Providing support may be aimed at enhancing the lifetime of the tools as much as possible to make them as cost effective as possible while at the same time ensuring the possibility of the tools being returned and recycled. When properly used, it is believed that a tool comprising a superhard material may have a greater lifetime than tools using traditional materials. The method may also include that the first party may provide 208 support to the second party whenever it is needed.

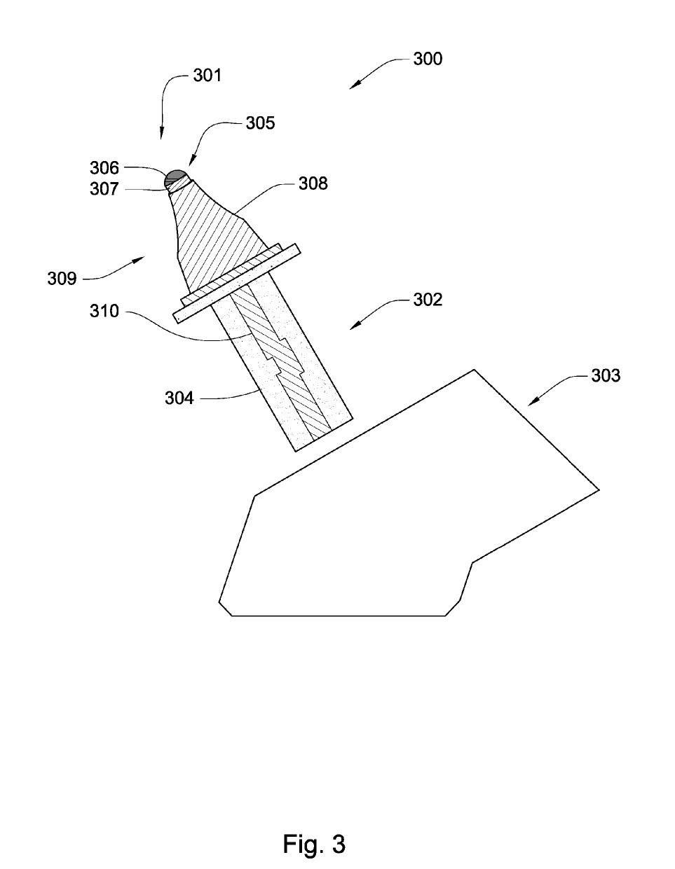

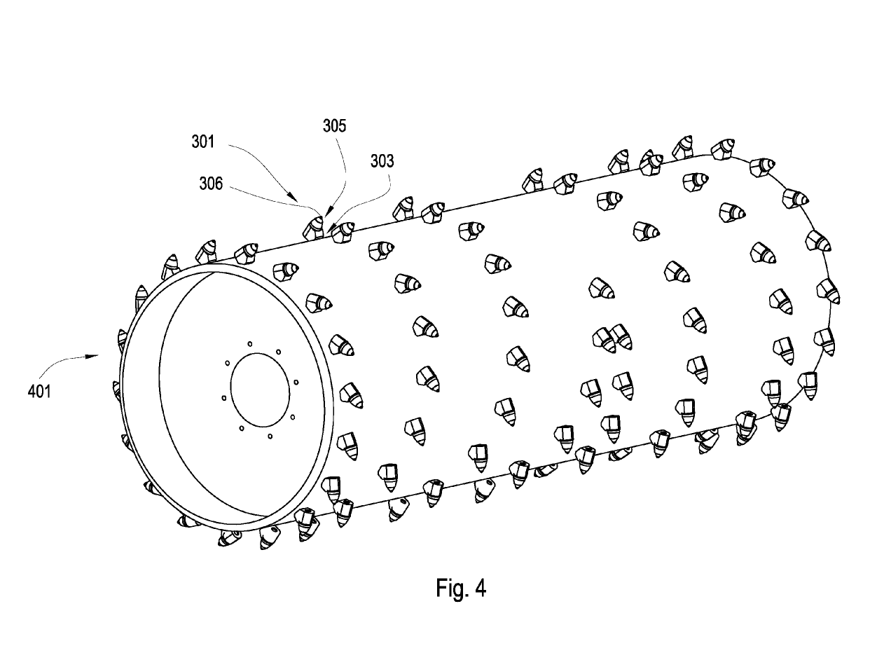

FIG. 3 is an orthogonal diagram of an embodiment of an at least one tool and a holder. The tool 300 may be selected from the group consisting of picks, screeds, rippers, scarifiers, and grinders. The tool 300 in FIG. 3 is a pick 301. The tool 300 comprises a first end 302 which may be adapted for connection to a part of a motor vehicle, which may be a pick holder 303. The pick 301 and pick holder 303 may be connected to another part of the motor vehicle which will be discussed in FIG. 4. The tool's first end 302 may have a metal sheath 304 around a shaft 310 of the tool to facilitate any rotation that occurs while the pick is held in place by the holder 303. Rotation may be preferable, because it may distribute wear over a surface of the tool 300. The second end 309 of the tool may comprise a tip 305 comprising a superhard material 306. The superhard material 306 may be bonded to a cemented metal carbide 307. The superhard material may comprise diamond, polycrystalline diamond, boron nitride, or combinations thereof. The cemented metal carbide may be bonded to a larger mass 308 of high-strength steel, hardened alloys, metal carbides, or cemented metal carbide. The mass 308 may be bonded to the shaft 310 of high-strength steel, hardened alloys, metal carbides, or cemented metal carbide. The shaft 310 may also include a surface coating such as ceramic, steel, ceramic-steel composite, steel alloy, bronze alloy, tungsten carbide, polycrystalline diamond, cubic boron nitride, or other heat-tolerant, wear-resistant surface coating known to those in the art.

Picks 301 may be attached to a motor vehicle by a holder 303. The holder 303 may comprise a socket which receives the first end 302 of the pick 301. The holder 303 may be angled to angle the pick 301 so that the second end 309 of the pick 301 strikes the pavement in a way that may decrease wear and/or stress on the pick 301.

FIG. 4 is a perspective diagram of an embodiment of a part of a motor vehicle adapted to receive a first end 302 of a pavement degradation tool 300. The part is a generally cylindrical mass 401 adapted to receive the first end 302 (not shown) of the tool 300. The cylindrical mass 401 may rotate proximate a paved surface such that the second end 309 of the tool 300, which comprises a superhard material 306, engages the paved surface. The tools 300 on the cylindrical mass 401 may be arranged in different configurations to enhance performance. For example, the tools may be arranged to move degraded pavement toward a conveyor belt or spaced closer or further apart to produce different sizes of degraded pavement. The cylindrical mass 401 may rotate clockwise or counter-clockwise to cause the tools to engage the top or side of the paved surface.

The cylindrical mass 401 may be positioned in various places on the motor vehicle. Typically, the cylindrical mass 401 is secured underneath the vehicle.

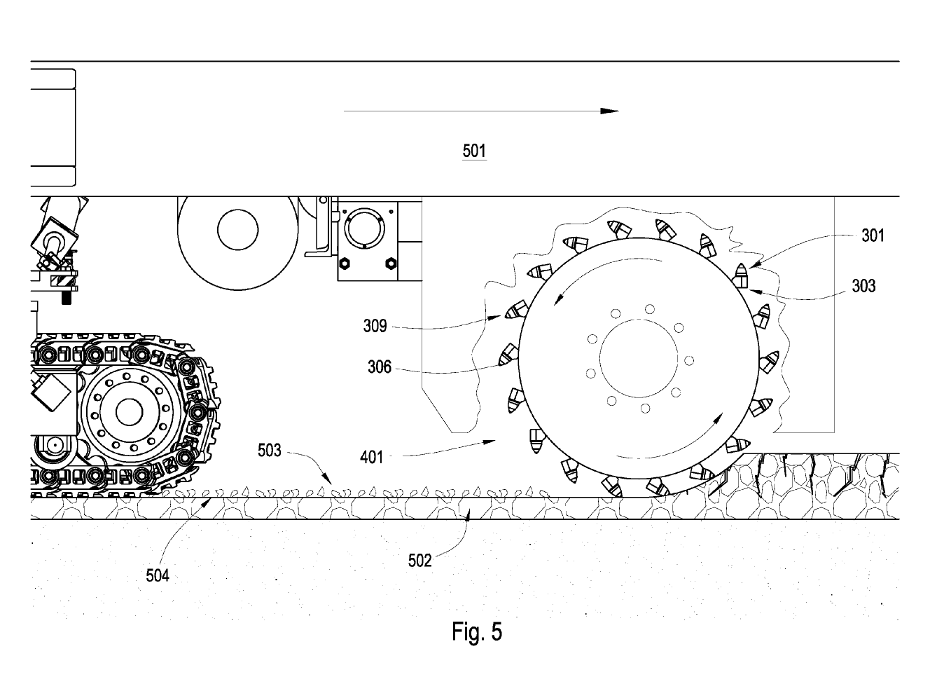

FIG. 5 is an orthogonal diagram of an embodiment of tools on a rotating drum attached to a motor vehicle. A plurality of tools 300, in this case picks 301, may be attached to a rotating cylindrical mass 401 which is rotating counter-clockwise. The cylindrical mass 401 may be adjusted to control the depth at which pavement 502 is being degraded.

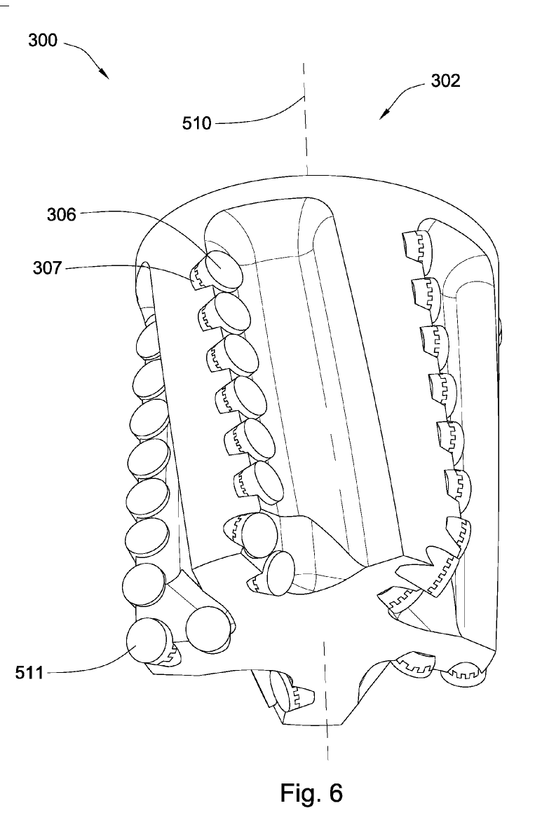

FIG. 6 is a perspective diagram of another embodiment of at least one tool. In some embodiments, the at least one tool 300 may be secured to the vehicle in such a manner that the tool 300 comprises a central axis that is non-parallel to the surface of the pavement. The tool comprises at least one insert 511 which may comprise a cemented metal carbide 307 bonded to a superhard material 306. The at least one insert 511 may be bonded into the tool as shown in FIG. 5. In other embodiments, the inserts 501 may be snapped into place or secured by some other mechanism. The first end 302 of the tool, which comprises a central axis non-parallel to the paved surface, may connect to a rod that is fixed to the motor vehicle.

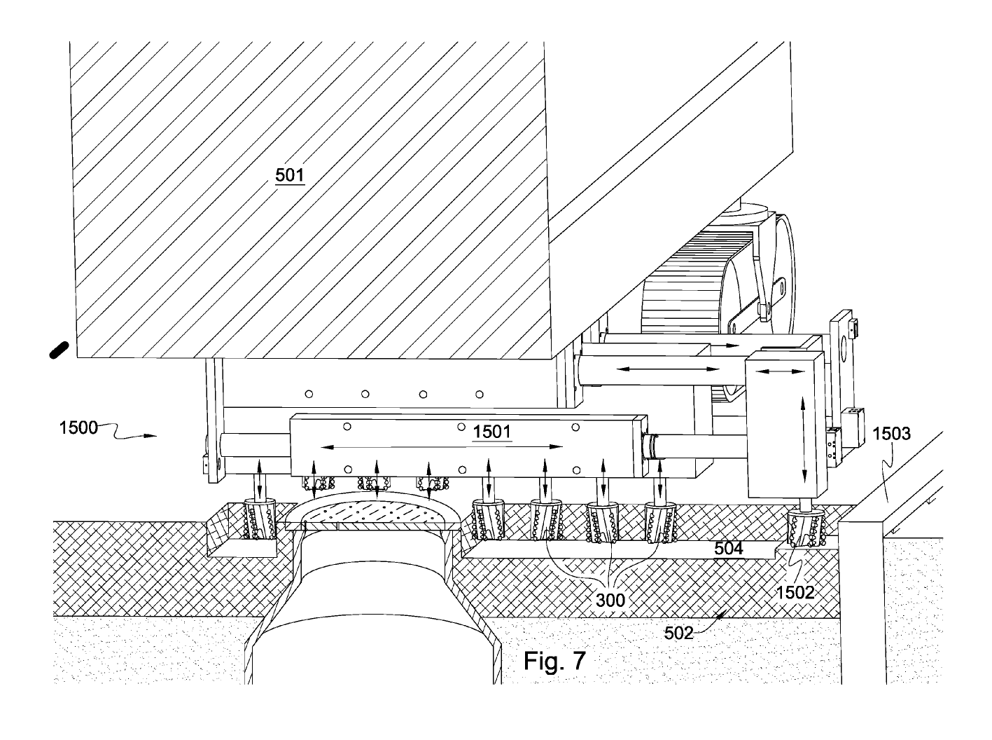

FIG. 7 is a cross-sectional perspective diagram of an array of tools 300. The tools 300 may be attached to a support assembly 1500 of the motor vehicle 501. The support assembly 1500 may move the tools 300 back and forth allowing the tools 300 to degrade pavement 502, leaving a degraded surface 504 behind. Tool 1502 may be used to trim closer to a curb or make patterns in the pavement 502 such as rumble strips. Additionally, the tools 300 may be used to make trenches in the pavement 502.

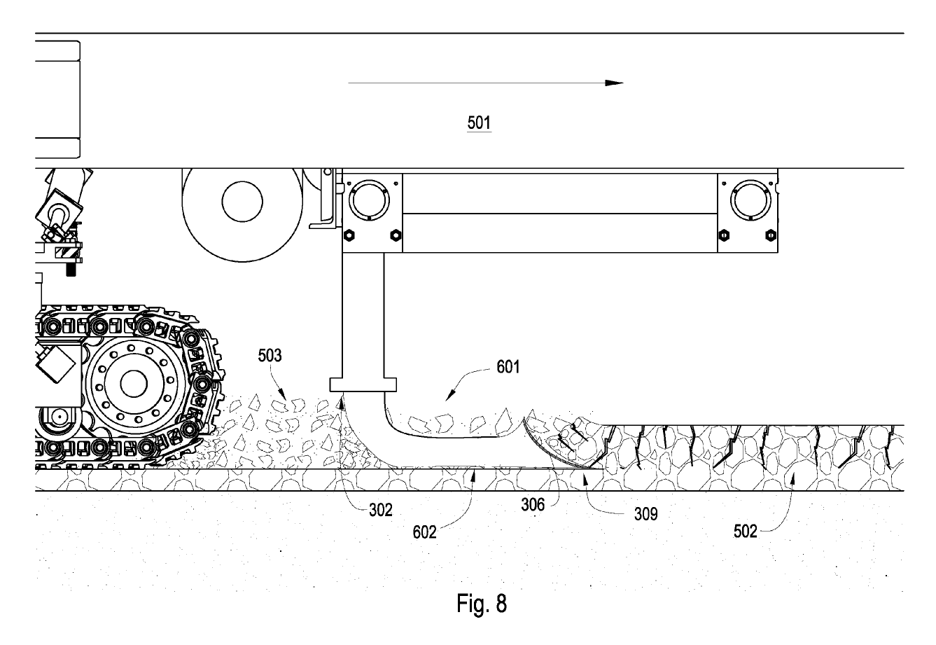

FIG. 8 is an orthogonal diagram of an embodiment of a ripper attached to a motor vehicle. A ripper 601 may include at least one ripper tool 602 to degrade pavement 502 while the motor vehicle 501. The size of degraded pavement 503 may depend on the number of and spacing between ripper tools 602. The second end 309 of the ripper 601 may comprise a superhard material 306. The degraded pavement 503 may be picked up or turned into rubble before additional work may be performed.

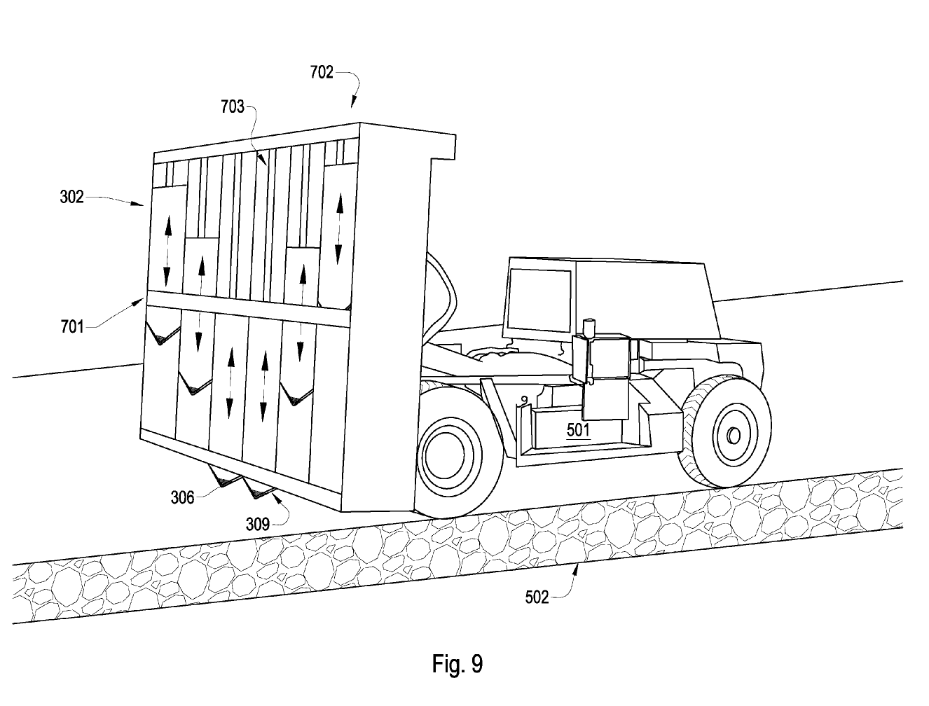

FIG. 9 is a perspective diagram of an embodiment of mechanized hammers 701 attached to a motor vehicle 501. The hammers 701 are an example of the at least one tool 300 that may be raised and dropped or extended from and retracted into the motor vehicle. The force of a dropped hammer 701 may be enough to fracture the pavement 502 Hammers 701 may also be useful to turn pavement 502 into rubble to be recycled or used as a new road base.

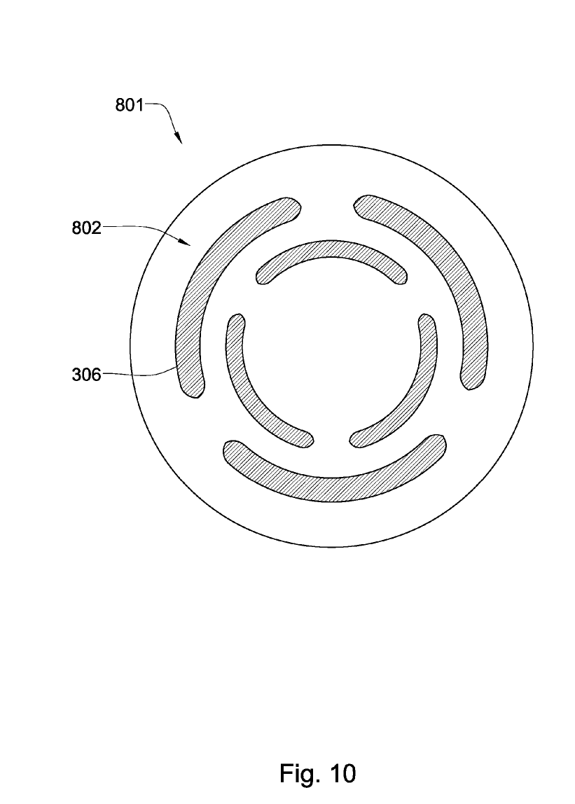

FIG. 10 is a bottom diagram an embodiment of a grinder pad 801. A grinder pad 801 may be attached to a motor vehicle and may be used to degrade pavement. Grinder pads 801 may have inserts 802 comprising a superhard material 306.

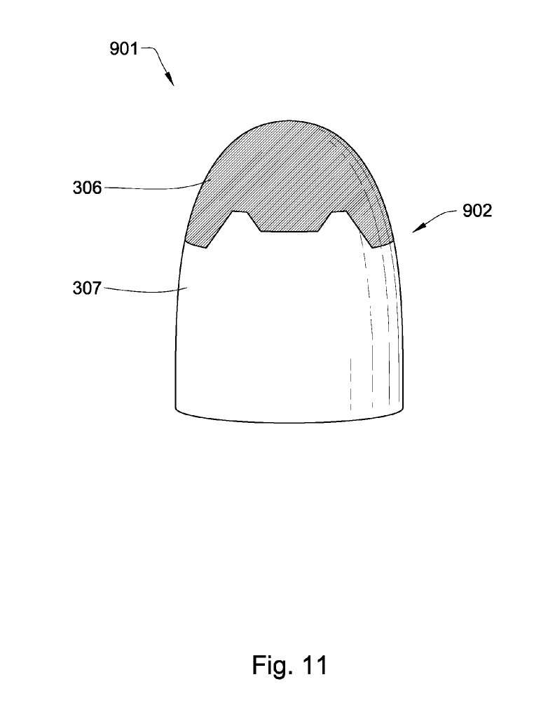

FIG. 11 is a perspective diagram of an embodiment of a second end of a tool. The tip 305 comprises a superhard material 306 bonded to a cemented metal carbide 307. The superhard material 306 may be diamond, polycrystalline diamond, boron nitride, or combinations thereof. The superhard material 306 may comprise a surface wherein at least a portion of is leached to remove a metal catalyst (such as cobalt).

The cemented metal carbide 307 may often be tungsten carbide, but other cemented metal carbides may also be used. The interface 902 between the superhard material 306 and the cemented metal carbide 307 is non-planar. A non-planar interface is beneficial because it strengthens the bond between the superhard material 306 and cemented metal carbide. FIG. 11 discloses an embodiment of a non-planar interface between the superhard material 306 and the cemented metal carbide 307. Those in the art appreciate that there are many varieties of non-planar interfaces and all such interfaces are included in this application.

FIG. 12 is a perspective diagram of an embodiment of surveyors measuring a volume of degraded pavement. Because the tools 300 are rented, they may be returned. It may be difficult to gauge how much work is done when working with tools comprising superhard materials because those materials may not wear if used properly. A first party may determine use of the tools before charging a second party. The use may be measured by a mechanism used to measure volume of degraded pavement, linear feet of degraded pavement, area of degraded pavement, amount of pavement degradation equipment, time that the pavement degradation equipment is in use by the second party, time that the pavement degradation equipment is in the second party's possession, wear of the equipment, number of times the second end of the at least one tool engages the pavement, weight of degraded pavement, or combinations thereof.

There are many possible ways to measure these different quantities. The mechanism for measuring the use of the tools may include, relaying data from the second party, job scope, having the first, second, or a third party calculate the use of the pavement degradation equipment according to volume of degraded pavement, linear feet of degraded pavement, area of degraded pavement, or combinations thereof; providing a mechanism that uses lasers to measure volume of degraded pavement, linear feet of degraded pavement, area of degraded pavement, or combinations thereof; providing software for use with the pavement degradation motor vehicle that measures the distance traveled by the pavement degradation vehicle, the number of times the second end engages the pavement, or combinations thereof; having the first, second, or a third party weigh material degraded by the pavement degradation equipment; using a system to track time the pavement degradation equipment is in the possession of the second party; and measuring dimensions of the returned tool and comparing those measurements to measurements taken before the equipment was provided.

Still referring to FIG. 12, first and second surveyors 1001, 1002 from the first party, second party, third party, or combinations thereof, are measuring the volume of degraded pavement. This may be done by measuring the length 1004, the width 1003, the depth 1005, or combinations thereof of the degraded surface 504. The depth 1005 may be measured by taking the difference of the height of the pavement 502 and the surface 504 left after degrading. This may be beneficial in that the volume of the actual degraded pavement may not be verifiable if the pavement is recycled in place or the pavement is entirely removed and transported away from the site.

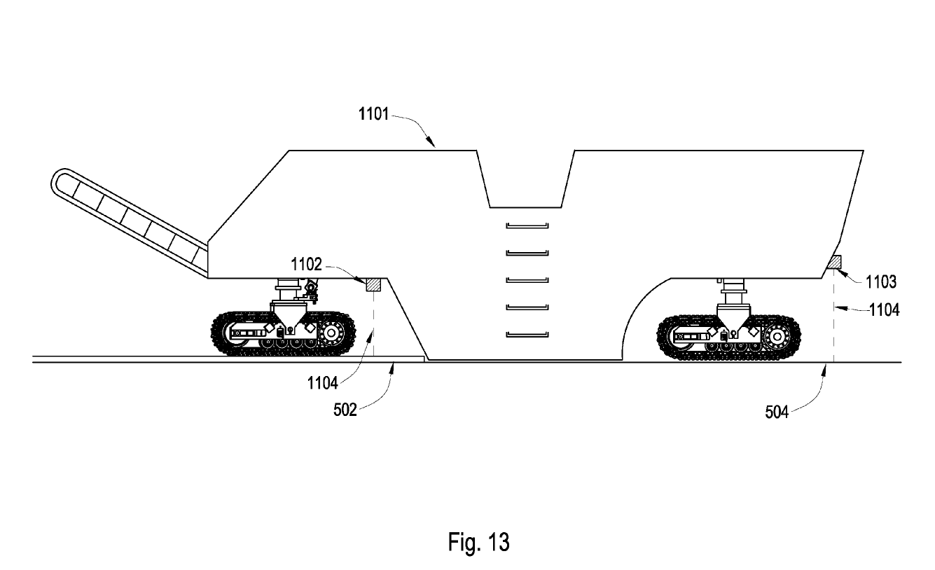

FIG. 13 is an orthogonal diagram of an embodiment of a laser system attached to a motor vehicle. The laser system is used to measure both distance traveled and depth of cut. The system may comprise at least one laser unit 1102 which may comprise a laser emitter, a memory device such as a hard drive or flash memory device, and a power source. Laser units 1102, 1103 may be placed at both ends of the vehicle 1101. The laser unit 1102 at the front of the vehicle 1101 may measure the distance to the pavement 502 before degradation occurs. The laser unit 1103 at the back of the vehicle 1101 may measure the distance to the new surface 504 after degradation has taken place. In some embodiments, units 1102, 1103 or both may record the distance the vehicle 1101 travels. With at least some of the information provided from the laser system the volume, linear feet, or area of degraded pavement may be measured.

What is claimed is:

1. A method for providing pavement degradation equipment, comprising:
a first party providing pavement degradation equipment to a second party;
the pavement degradation equipment comprising at least one tool comprising a first end adapted for connection to a motor vehicle and a second end comprising a superhard material for engagement with the pavement;
using a rental agreement comprising terms of payment based on use of the equipment;
the first party providing a mechanism for measuring the use of the equipment; and
the first party charging the second party for use of the equipment according to the terms of the rental agreement.

2. The method of claim 1, wherein the pavement degradation equipment comprises at least one part of the motor vehicle.

3. The method of claim 2, wherein the at least one part is a generally cylindrical mass adapted to receive the first end of the tool, the mass being adapted to rotate proximate a paved surface such that the second end of the tool engages the paved surface.

4. The method of claim 1, wherein the at least one tool is secured to the motor vehicle.

5. The method of claim 1, wherein the at least one tool is adapted to extend from and retract into the pavement degradation motor vehicle.

6. The method of claim 1, wherein the at least one tool is selected from the group consisting of picks, screeds, rippers, scarifiers, and grinders.

7. The method of claim 1, wherein the superhard material is diamond, polycrystalline diamond, boron nitride, or combinations thereof.

8. The method of claim 1, wherein the superhard material comprises a surface wherein at least a portion of the surface is leached.

9. The method of claim 1, wherein the superhard material is bonded to a cemented metal carbide.

10. The method of claim 9, wherein an interface between the superhard material and cemented metal carbide is non-planar.

11. The method of claim 1, wherein the use is determined by measuring, selected from the group consisting of volume of degraded pavement, linear feet of degraded pavement, area of degraded pavement, amount of pavement degradation equipment, time that the pavement degradation equipment is in use by the second party, time that the pavement degradation equipment is in the second party's possession, wear of the equipment, number of times the second end of the at least one tool engages the pavement, weight of degraded pavement, or combinations thereof.

12. The method of claim 1, wherein the use is determined by type of pavement degradation equipment, material being degraded, or combinations thereof.

13. The method of claim 1, wherein the rental agreement comprises a description of what the second party will do with the pavement degradation equipment.

14. The method of claim 13, wherein the description of what the second party will do with the pavement degradation equipment comprises actions selected from the group consisting of the second party changing the tool after a pre-determined time and the second party returning used and/or unused tools.

15. The method of claim 1, wherein the rental agreement includes a provision providing an incentive to the second party for returning the at least one tool with undamaged superhard material.

16. The method of claim 1, wherein the first party allows the superhard material to be recycled by the first party, the second party, or a third party.

17. The method of claim 1, wherein the mechanism for measuring use of the pavement degradation equipment comprises mechanisms selected from the group consisting of relaying data providing by the second party, job scope, having the first, second, or a third party calculate the use of the pavement degradation equipment according to volume of degraded pavement, linear feet of degraded pavement, area of degraded pavement, or combinations thereof; providing a mechanism that uses lasers to measure volume of degraded pavement, linear feet of degraded pavement, area of degraded pavement, or combinations thereof; providing software for use with the pavement degradation motor vehicle that measures the distance traveled by the pavement degradation vehicle, the number of times the second end engages the pavement, or combinations thereof; having the first, second, or a third party company to weigh material degraded by the pavement degradation equipment; using a system to track time the pavement degradation equipment is in the possession of the second party; and measuring dimensions of the returned tool and comparing those measurements to measurements taken before the equipment was provided.

18. The method of claim 1, further comprising the step of providing support to the second party by the first party.

19. The method of claim 18, wherein providing support comprises repairing the rented pavement degradation equipment, maintaining the rented pavement degradation equipment, replacing rented pavement degradation equipment that is used or broken, inspecting rented pavement degradation equipment, training operators of pavement degradation motor vehicles in the use of the rented pavement degradation equipment, or combinations thereof.

20. The method of claim 1, wherein the at least one tool is a pick.

21. The method of claim 1, further comprising the step of the first party receiving payment for the use of the equipment.
